(19) United States
(12) Patent Application Publication
(10) Pub. No.: US 2018/0082181 A1
(43) Pub. Date: Mar. 22, 2018

(54) Neural Network Reordering, Weight Compression, and Processing

(71) Applicant: Samsung Electronics, Co. Ltd., Suwon si (KR)

(72) Inventors: John BROTHERS, Calistoga, CA (US); Zhengping JI, Pasadena, CA (US); Qiang ZHENG, Pasadena, CA (US)

(21) Appl. No.: 15/421,423

(22) Filed: Jan. 31, 2017

Related U.S. Application Data
(60) Provisional application No. 62/336,493, filed on May 13, 2016.

(51) Int. Cl. G06N 3/08; G06N 3/04

(52) U.S. Cl. CPC G06N 3/082; G06N 3/04

(57) ABSTRACT

A neural network is trained to generate feature maps and associated weights. Reordering is performed to generate a functionally equivalent network. The reordering may be performed to improve at least one of compression of the weights, load balancing, and execution. In one implementation, zero value weights are grouped, permitting them to be skipped during execution.

### CROSS REFERENCE TO RELATED APPLICATIONS

The present application claims the benefit of U.S. Provisional Application No. 62/336,493 filed May 13, 2016, the contents of which are hereby incorporated by reference.

### FIELD OF THE INVENTION

An embodiment of the present invention is generally related to neural networks.

### BACKGROUND OF THE INVENTION

Artificial neural networks (NNs) can be designed and trained to perform a wide-range of functions. Example applications of NNs include image processing, speech recognition, data processing, and control, among other applications. Models of NNs can include a large number of layers and parameters (weights). Processors with highly-parallel architectures, such as graphics processing units (GPU), can facilitate efficient implementation of large NNs.

### BRIEF DESCRIPTION OF THE DRAWINGS

FIG. 1 is a block diagram illustrating reordering of feature maps and weights of a neural network in accordance with an embodiment.

FIG. 2 illustrates a portion of a neural network in accordance with an embodiment.

FIG. 3 illustrates a portion of a neural network in accordance with an embodiment.

FIG. 4 illustrates a method of reordering a neural network in accordance with an embodiment.

FIG. 5 illustrates a method of executing a reordered neural network in accordance with an embodiment.

FIG. 6 illustrates a method of reordering a neural network that includes pruning in accordance with an embodiment.

FIG. 7 illustrates a method of executing a reordered neural network to skip zero value weights in accordance with an embodiment.

FIGS. 8A and 8B illustrate reordering to improve load balancing in accordance with an embodiment.

FIGS. 9A and 9B illustrate Huffman coding of weights in accordance with embodiments.

FIG. 10 illustrates mask stream decoding and value stream decoding in a neural network in accordance with an embodiment.

### DETAILED DESCRIPTION

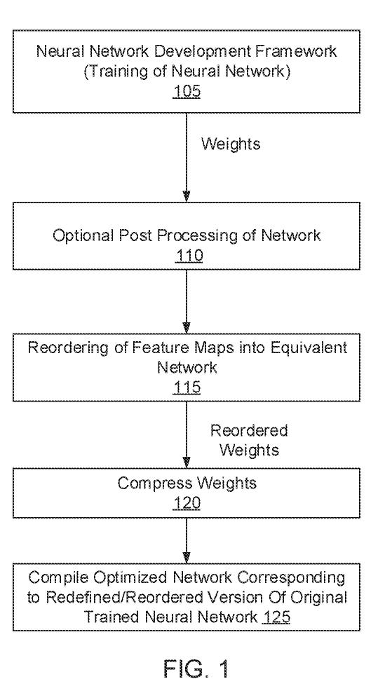

FIG. 1 is a high level block diagram in accordance with an embodiment. In one embodiment, a neural network (NN) development framework 105 generates a set of weights for all of the layers of the network. In one embodiment, additional processing of the weights is performed offline on a computer system. In one embodiment, an optional post-processing 110 is performed that includes pruning, which eliminates many weights by setting them to zero (0), as described below in more detail. A reordering of feature maps 115 is performed that results in an equivalent network with reordered weights. The reordered weights are compressed 120. An optimized network is compiled 125 corresponding to a reordered version of the original trained neural network. In one embodiment, a neural network utilizing the compressed weights may be implemented to utilize parallel processing. Additionally, a neural network utilizing the compressed weights may be implemented to not require processing whenever all input weight values to the parallel processors have a zero value.

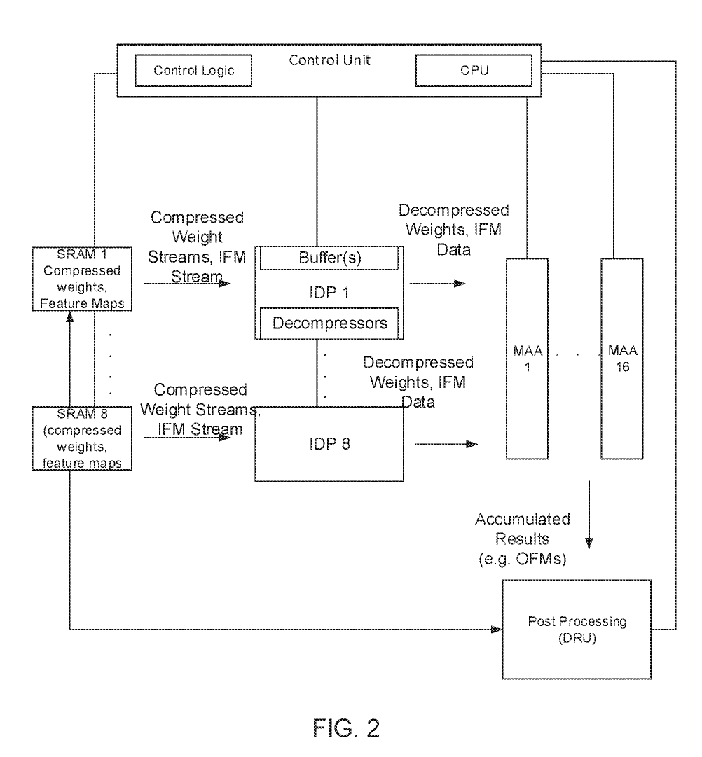

FIG. 2 is a block diagram of an example of a portion of a neural network utilizing the compressed weights in accordance with an embodiment. Memories (e.g., Static Random Access (SRAM) memories) are provided to store compressed weights and input feature maps (IFMs). In one embodiment, a control unit includes dedicated control logic to control the parallel units and a central processing unit (CPU) that works in combination to control operation of the SRAM memories, multiply-accumulate array (MAA) units, and input data path (IDP) units. In many NNs, such as convolutional NNs, numerous computations may be implemented as operations based on operations that can be calculated using MAA units.

In one embodiment, each IDP unit receives compressed weights and inputs feature map data and outputs decompressed weights and IFM data to the MAA units. For example, each IDP may include at least one decompressor, and a buffer to buffer input data. In one embodiment, the accumulated results of the MAAs correspond to output feature map data (OFM) and intermediate results. One or more units (labeled in FIG. 2 as DRUs) may be provided to support additional processing functions on the outputs of the MAA units, such as rescaling, adding bias, applying activation functions, and pooling. In one embodiment, the MAAs receive an IFM from each IDP as well as non-zero weights.

The number of IDPs in one embodiment is eight, although more generally, different numbers of IDPs may be used. In one embodiment, each IDP unit runs in parallel, each supplying one non-zero weight and one set of feature maps values (as subset of the IFM) to a MAA computation unit. In one embodiment, the input units iterate over subsets of the IFMs and corresponding weights over multiple cycles to generate a set of OFMs in parallel.

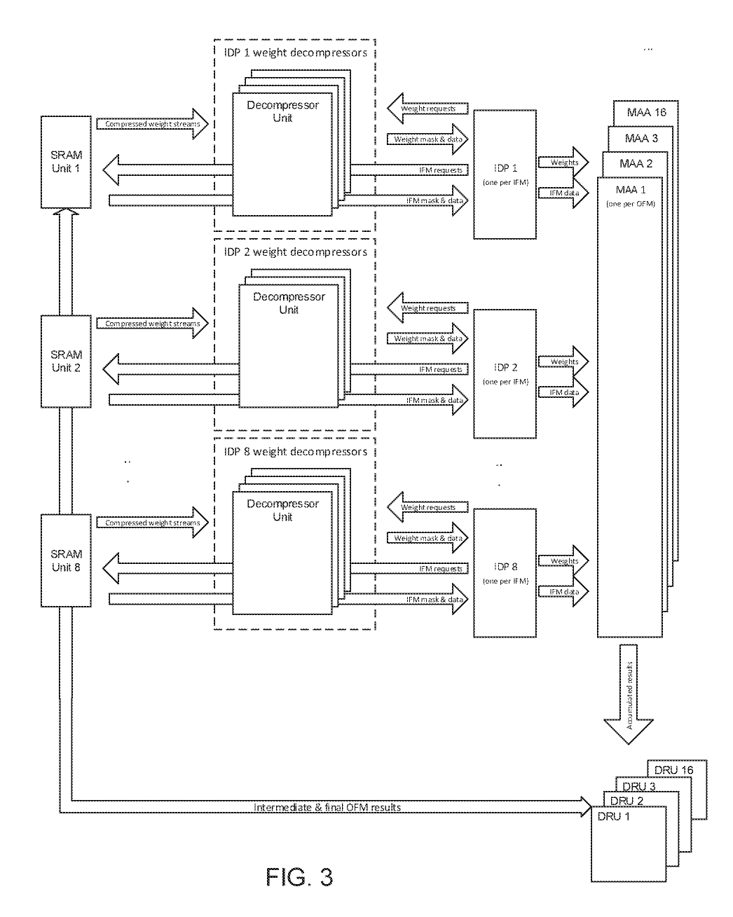

FIG. 3 shows in more detail an example of some of the data streams that feed the MAA units in accordance with an embodiment. For the purposes of illustrations, eight parallel IDPs and 16 MAAs are illustrated. However, more generally, an arbitrary number of units may be configured to support parallel processing. For example, with 8 SRAM units, each individual SRAM stores a fraction (e.g., ⅛) of the weights. In one embodiment, an individual IDP provides one non-zero weight to a MAA and one IFM (e.g., a 4×4 block) to each of the MAAs.

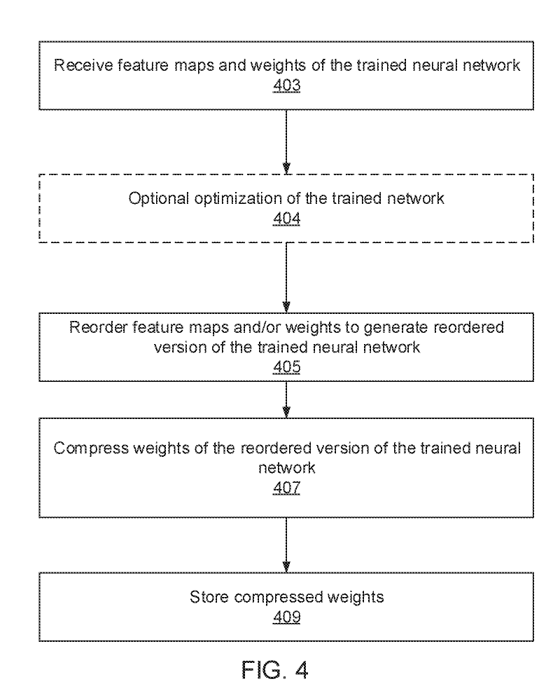

FIG. 4 is a flow chart illustrating a method of generating compressed weights of a reordered NN in accordance with an embodiment. The feature maps and weights of the trained neural network are received 403. An optional optimization 404 of the trained network may be performed. The feature maps and/or weights are reordered to generate 405, a reordered version of the trained neural network. After the reordering, the weights of the reordered version of the trained neural network may then be compressed 407 and stored 409 (e.g., in a memory of a neural network device, although more generally the compressed weights could be stored in a storage medium or storage unit).

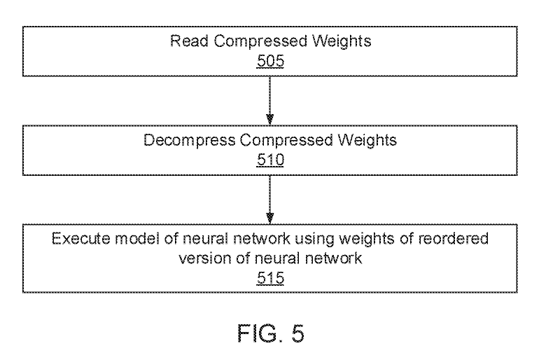

The stored compressed weights may then be used to execute a neural network, as illustrated in the flow chart of FIG. 5. The compressed weights are read 505 and decompressed 510. A model of the neural network is executed 515 using the weights of the reordered version of the neural network.

NN training algorithms typically result in the feature maps of the layers of the NN being arbitrarily organized in memory. As a consequence, the weights that correspond to the feature maps will also typically be arbitrarily organized in memory. This arbitrary organization, in turn, impacts compression and execution efficiency. One aspect of reordering is that there are a number of functionally equivalent orderings of a neural network. However, some of the functionally equivalent orderings can be selected to have a structure that can be exploited to achieve better compression rates than others. By way of illustration, suppose that feature maps 0 and 10 of a layer can be swapped with no impact on the NN's input-output relationship, provided the layer makes a corresponding swap of weights. The same weights are applied to the same inputs and those results are summed together with the same results in both the original and reordered networks. However, the reordering may be selected to result in a structure that is better suited for compression and/or has advantages for execution. For example, weights of a NN can be reordered so that similar weights are grouped together in memory. That is, after training of a NN and before compression of its weights, the NN's feature maps, and by extension, the weight values, can be reordered.

In one embodiment, the neural network reordering may be selected to introduce an ordering to the weights to increase the ability to compress the weights (i.e., reduce the amount of data that is used to represent the NN). By reordering network layers, an ordering can be introduced to the weights that are selected to provide better weight compression. One option is to perform the reordering to improve compression by introducing a structure to the weights that aids in compressing them. For example, weights may be grouped or ordered by value. Still another option is to perform the reordering based on characteristics of a coding technique used for compression, such as Huffman coding or Golomb-Rice coding. As an example, feature maps can be reordered so that frequency distributions are sharper in a particular localized area. Additionally, the reordering may be selected to improve prediction accuracy in the encoding. As another example, network feature maps can be reordered so that weight values tend to increase or the number of zero value weights increase.

Also, by redistributing non-zero weights, it is possible to more effectively skip over zero-value-weights during network execution. One option is to perform reordering to group zero value weights to permit them to be skipped during execution.

As still yet another example, weights may be reordered to create a better load balancing during parallel processing of neural network model. For example, the reordering may perform to achieve a reordering in which each processing unit, in the parallel processing, is supplied a more equal number (e.g., about the same number) of non-zero weights over a selected number of cycles.

In one embodiment, network pruning and weight clustering of selected weights may be performed after network training. Clustering includes, for example, mapping a number of different weight values to a smaller number of weight values to improve compression. For example, a thousand or more slightly different weights might be mapped to 32 weight values. Clustering is also sometimes referred to as quantization. In one embodiment, low magnitude weights are pruned (set to zero). In one embodiment, the pruning is performed without impacting network accuracy. In a pruning step, low magnitude weights are clamped to zero. The remaining non-zero weights may then be adjusted through network retraining to regain any lost accuracy. That is, to counteract loss of accuracy,

retraining can be done to readjust certain weights so that the overall network maintains the same or nearly the same accuracy, while maintaining the compression advantages.

In one embodiment, pruning increases the percentage of zero-value weights. This has potential advantages for compression and also execution. During execution in an end NN device, a number of weights may be applied in parallel in a given cycle in SIMD fashion (e.g., either all parallel compute units apply a weight or all skip a zero—value weight). That is, there is no need to apply weights equal to zero during execution, since these have no effect. In some cases, pruning can result in a large proportion of the weights ending up being zero (e.g., about 60% to 95% or more), which in turn, provides an opportunity to speed up network execution.

In one embodiment, zero-value weights are grouped to improve execution. It can be difficult to eliminate processing cycles for many of the zero-valued weights. However, a number of zero-value-weights can be skipped when they are grouped so that they are collected together in the same cycle. This can help speed up execution and improve compression at the same time.

In addition to reordering the network and lossless compression of the reordered weights, example embodiments can also utilize lossy compression, which can be omitted in other embodiments. In this case, together with reordering, adjustments (e.g., small adjustments) are made to the weights to improve compression.

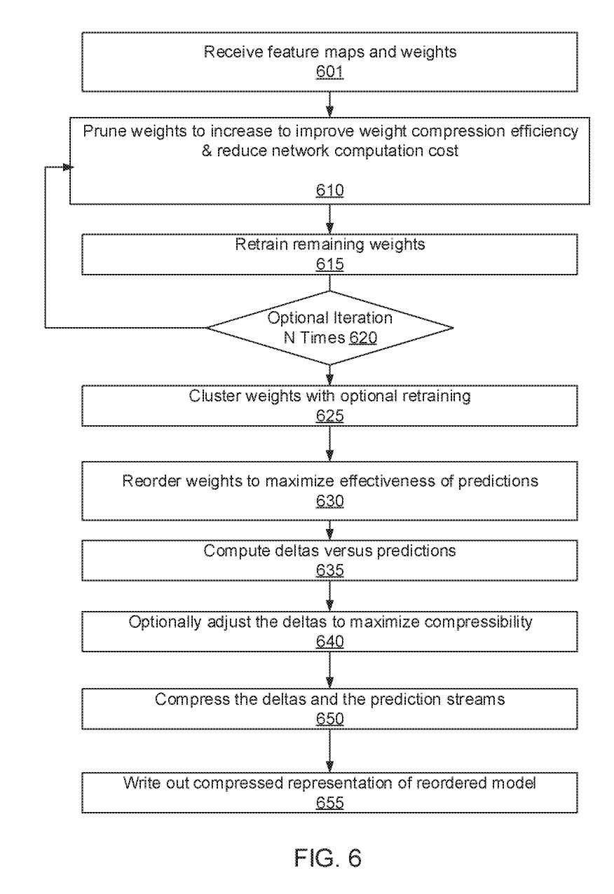

FIG. 6 illustrates a method including pruning and retraining in accordance with an embodiment. Features maps and weights of a trained neural network are received 601.

Weights are pruned 610 to improve weight compression efficiency and reduce network computation cost. In one embodiment, the pruning is performed with variable thresholds. For example, the threshold can be selected based on a predetermined scaling factor of distance measures of the weights. In an example embodiment, the threshold is selected as a value equal to about 20% of the L1 hamming distance of each weight vector in fully connected layers or each convolutional kernel in convolutional layers. Different scaling factors or different distance measures can be used in alternative embodiments. In another example, the threshold can be found iteratively via dynamic programming to maximize zero values in each cluster generated with a regularization that bounds the threshold is satisfied.

The remaining weights are retrained 615. As indicated by block 620, in some embodiments an option may be included to repeat the pruning and retraining one or more times, until a stopping condition is satisfied, such as a preset number of iterations is met.

Quantization of the weights 625 may be performed with optional retraining. In an example embodiment, the clustering of weights is conducted based on k-means clustering, where the centroid of each cluster is used to represent the weights included in that cluster.

The sets of quantized weights are reordered 630. As previously discussed, reordering may include reordering corresponding to switching around feature maps or feature map nodes in fully-connected layers. However, the reordering may also include reordering to improve compression. The reordering may include reordering into clusters and reordering based on column and row attributes. Sets of quantized weights within clusters may also be selected to maximize effectiveness of predictions. For example, the reordering may include a reordering in which cluster 0 is the most common and cluster 31 is the least common. As one option, columns may be reordered into clusters of a selected number of columns (e.g. 16, depending on implementation details) into increasing order to maximize the effectiveness of some inter-column compression. Additionally, rows may be reordered within a group of columns to effectively compress iteratively in the row dimension. For example, row 1 elements are predicted to be the same as row 0, plus some small positive delta and the deltas are compressed. Clusters can be any suitable number of columns in alternative embodiments. Clusters can be formed from any suitable elements (e.g., rows) in alternative embodiments.

The deltas are computed versus prediction 635. For example, the differences between adjacent columns and/or rows in a cluster may be computed. Other transformation may be applied to a “base” column or row used to make predictions for the other columns and rows. For example, suppose column 0 is selected as a “base” column and all other columns in a group (e.g., of 16 columns) are predicted by different scale factors applied to the base column. For example, a row may be predicted to be row 0 multiplied by a scale factor, plus some deltas. In some cases, the deltas will be small.

An optional adjustment 645 of the deltas may be performed to improve compressibility and then retraining performed to mitigate accuracy loss. For example, a delta value might be adjusted up or down a small amount in order to improve compressibility. This adjustment would be a lossy component of the compression scheme.

The deltas and the base prediction are then compressed 650. A coding scheme, such an entropy coding scheme, may be used. For example, Huffman coding may be used represent the deltas with a number of bits. Efficient compression can be achieved by representing the most common deltas with the fewest possible bits.

The compressed representation of the reordered model is then written 655 to data storage.

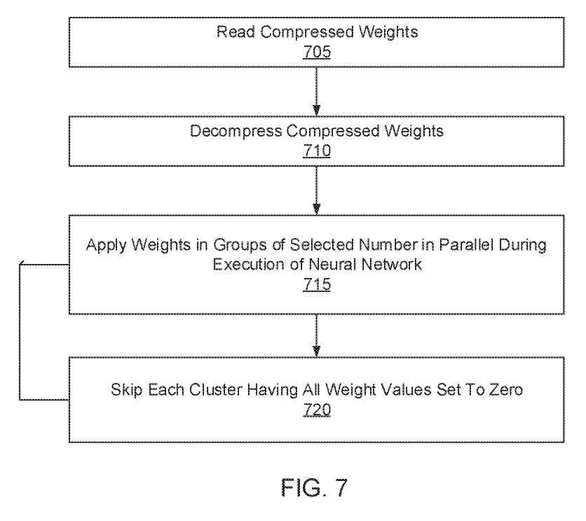

FIG. 7 is a flowchart illustrating a method of execution that includes skipping zero value weights in accordance with an embodiment. The compressed weights are read 705. The weights are decompressed 710. The weights are applied in groups of selected numbers (e.g., 16, depending on implementation details) in parallel during execution of the neural network. Whenever a cluster of values (for a group) has all of it weights set to zero, the cluster is skipped 720. Otherwise, the execution of the neural network processes convolutions and vector products as in a conventional neural network execution.

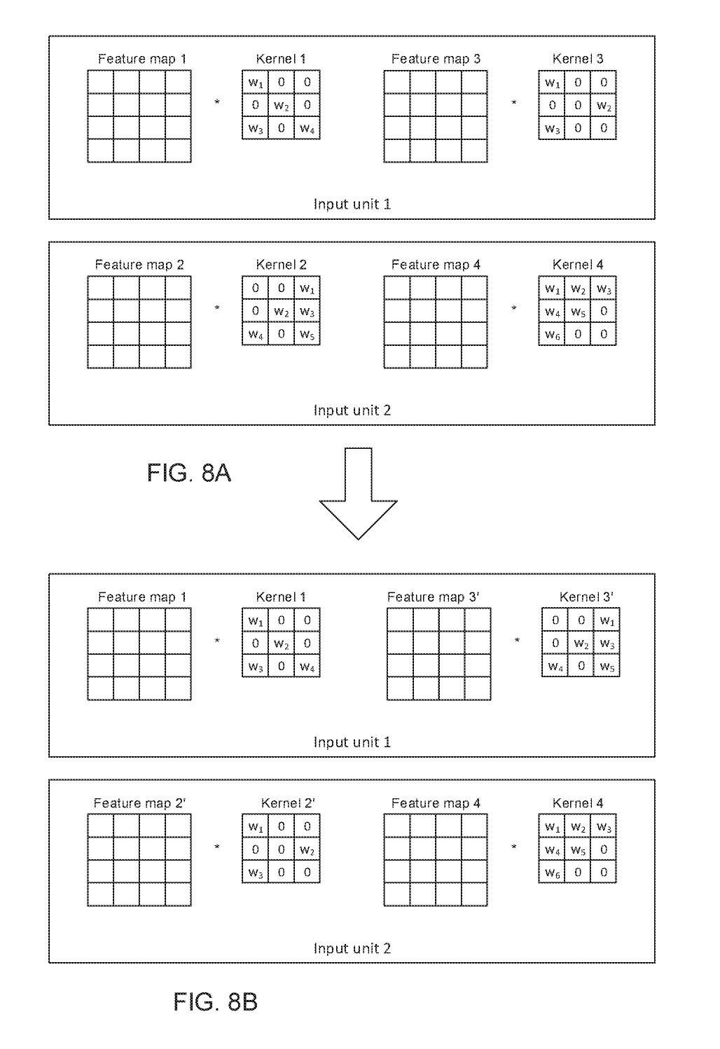

In one embodiment, the manner in which zero values are handled depends in part on the layer type (e.g., convolutional layer vs. fully connected layer). That is, the way in which skipping zero-value weights is implemented depends on the layer type (which in turn corresponds to different mathematical operations, such as vector-product operations for fully connected layers and convolutional operations for convolutional layers). For example, zero-value weights may be grouped to more efficiently skip them in a fully connected layer in which vector products are calculated. However, for a convolutional layer, the zero values may be distributed (spread out) to aid in load balancing in parallel computational units. This is because there is no need to group zero weights to be able to skip processing zero values in a convolution operation for a convolution layer. Consider an example for a convolution layer in which there is load balancing. In this example, each input unit finds the next non-zero weight for its subset of inputs and moves to that weight. So each input unit moves at different rates through its input data, hopping from one non-zero weight to the next. They all move through their data at different rates. Provided each input unit has about the same number of non-zero weights to apply over their subsets of input, the system is load balanced and effectively skips cycles that would have been needed to apply zero-value weights. FIG. 8A and 8B illustrate an example of reordering to improve load balancing in a convolution layer. FIG. 8A illustrates an example in which there are two input units (input unit 1 and input unit 2). Input unit 1 processes feature map 1 and kernel 1 (where the*operation is a convolution operation); and feature map 3 and kernel 3. Input unit 2 processes feature map 2, kernel 2 and feature map 4, kernel 4.

FIG. 8A illustrates an example, without reordering, in which there is a large load imbalance. Input unit 1 requires 4 cycles to emit the four non-zero weights in kernel 1 and then 3 cycles to emit the three non-zero weights in kernel 3, for a total of 7 cycles. Input unit 2 requires 5 cycles to emit the 5 non-zero weights in kernel 2 and then 6 cycles to emit the non-zero weights in kernel 4, for a total of 11 cycles. Thus, 11 cycles are required overall to process four features maps over the two input units due to the load imbalance.

FIG. 8B illustrates an example, in accordance with an embodiment, in which reordering shuffles the IFMs in the network to get an equivalent network that is more load balanced. Feature map 2 and feature map 3 are swapped by redefining the neural network and there is also swapping of the corresponding weight kernels. Thus, feature map 3 is reordered to feature map 3′ which has a corresponding kernel 3′. There is also reordered feature map 2′ and corresponding kernel 2′. In this example, the reordering results in greater load balancing. Input unit 1 requires 4 cycles to emit the four non-zero weights in kernel 1 and then 5 cycles to emit the non-zero weights of kernel 3′, for a total of 9 cycles to process feature map 1 and feature map 3′. Input unit 2 requires three cycles to emit the three non-zero weights in kernel 2′ and the six cycles to emit the non-zero weights in kernel 4, for a total of 9 cycles. Thus, in FIG. 8B, nine cycles are required to process the four feature maps over the two input units.

In one embodiment, hardware support is provided for load balancing to be performed on the fly. For example, offline processing may be performed to work out an optimal reordering of the IFMs and perform reordering of the OFMs. In one embodiment, remapping logic and remapping tables are supported to specify that variable remapping is performed during hardware execution of the network.

As previously discussed, reordering may result in an equivalent version of the same network, such as by swapping feature maps for different layers and swapping the corresponding weights (e.g., swapping maps 2 and 10 and swapping the weights that correspond to maps 2 and 10). However, in one embodiment, the reordering includes generating additional remapping tables to aid hardware in a neural processing unit. The remapping tables may instruct hardware to perform a swapping. For example, a remapping table may instruct hardware for output map 3 to swap input maps 2 and 10.

As previously discussed, a number of different data compression algorithms can be used for the weights, such as, but not limited to, Huffman coding or any other suitable compression algorithm, such as Golomb-Rice coding. Compression performance can depend on the organization of the data to be compressed. For example, compression can rely primarily on making predictions and representing the differences versus the prediction with a variable number of bits. For example, the more commonly-occurring values are compressed with fewer bits.

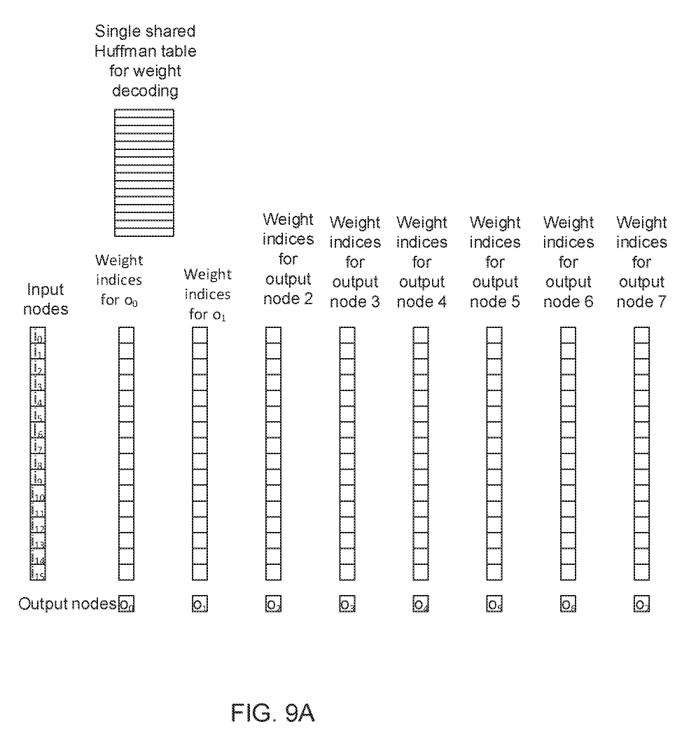

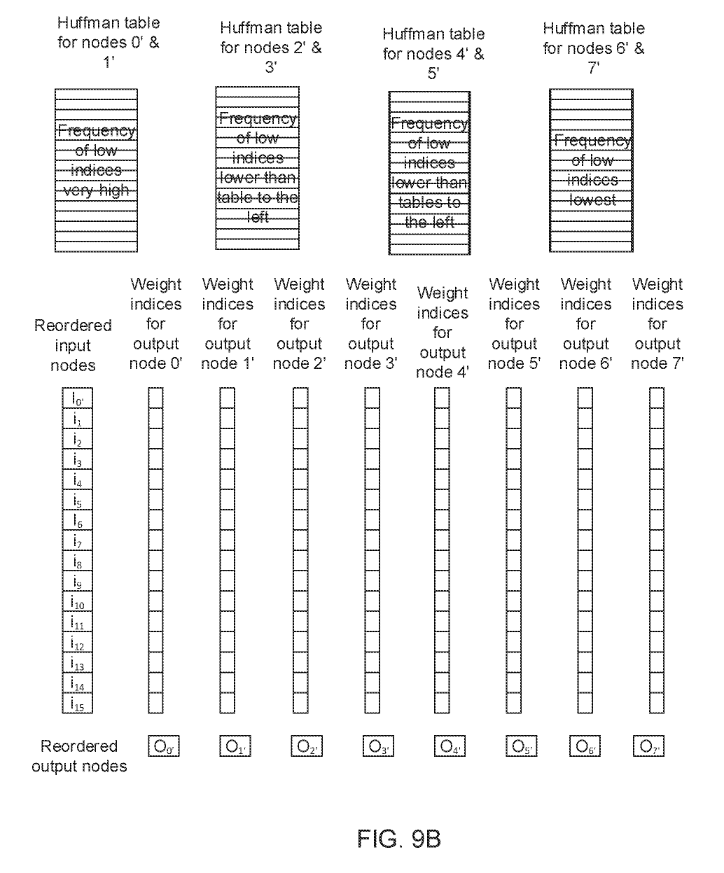

FIG. 9A and 9B illustrates aspects of Huffman coding in accordance with embodiments of the invention. As illustrated by FIG. 9A, in principle a single shared Huffman table may be used for weight decoding. For a set of weight indices for a sequence of output nodes (e.g., output node 0, 1 . . . 7). There is an even distribution of weight index usage in which low indices are more common than high indices. A single Huffman table is used to exploit the higher frequency of low indices throughout the whole set of weights. However, it is assumed in FIG. 9A that there is an even distribution of weight index usage—low indices are more common than high indices, but no more common in the left columns than the right ones. In the example of FIG. 9A, each of the columns of weight indices has a random order. For example, column O₀ has a random index distribution corresponding to whatever came out of training. Column O₁ has a random index distribution, and so on, for each of the columns of weight indices in FIG. 9A.

FIG. 9B illustrates the use of Huffman coding for context adaptive variable weight compression in accordance with an embodiment. Columns (and/or rows) may be sorted to generate an organization of weights with a frequency of low indices that permits two or more different Huffman tables to be used. For example, the distribution of weight index usage may be selected to have low indices more common than high indices for the left columns than the right ones. In the example of FIG. 9B, the reordering moves low-value weights to one side of a matrix and high values to the other side. After the reordering of the weight matrix, a set of Huffman tables is optimized for subsets of the nodes. For example, each table may correspond to a different set of nodes, with each table having a different frequency of low indices. As an example, consider first the two left-most columns. The column of weight indices for output node O_{0′} has low weight indices most common in this column. The column of weight indices for output node O_{1′} has a similar index distribution as the column to the left. The weight indices for the first two nodes (0′ and 1′) have a first Huffman table for nodes 0′ and 1′ corresponding to a frequency of low indices very high. Moving on to the next two columns, the column of weight indices for output node 2′ has low indices less common here than in the columns to the left. The column of weight indices for output node 3′ has a similar distribution as the column to the left. The weight indices for the nodes 2′ and 3′ have a second Huffman table for nodes 2 and 3. This ordering continues from left to right throughout the reordered output nodes, concluding with the column of weight indices for output node 6′ having low indices the least common and output node 7′ having a similar distribution as for output node 6′.

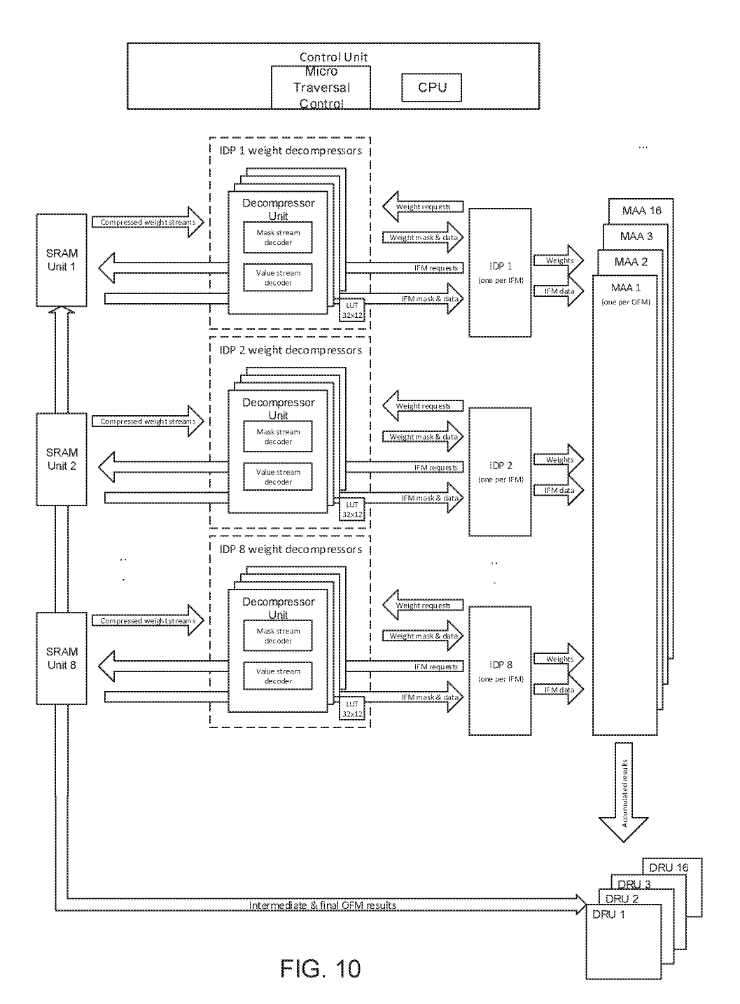

FIG. 10 illustrates an embodiment in which the IDP decompressors for Huffman or Golomb-Rice decoding include a compressed weight mask stream decoder and a compressed weight value stream decoder. In one embodiment, weight kernels are represented with masks specifying (pruned) weights and indices for non-zero weights. Additional look up tables (LUTs) may be provided to support decoding. In one embodiment, outputs include a zero-mask buffer and a weight values buffer.

Example embodiments can be deployed as an electronic device including a processor and memory storing instructions. Furthermore, it will be appreciated that embodiments can be deployed as a standalone device or deployed by multiple devices in distributed client-server networked system.

A non-limiting example of an execution environment for embodiments of the present invention is in Graphics Processing Units (GPUs). While GPUs can provide substantial computation power for implementing a NN, it can be difficult to implement a NN on a device with limited memory and/or power. Example embodiments disclosed herein can enable improved compression of neural network weight parameters for storage in a memory of a GPU and provide improved efficiency of network execution by clustering 0-value weights so they can be more effectively skipped.

Herein, a computer-readable non-transitory storage medium or media may include one or more semiconductor-based or other integrated circuits (ICs) (such, as for example, field-programmable gate arrays (FPGAs) or application-specific ICs (ASTCs)), hard disk drives (HDDs), hybrid hard drives (HHDs), optical discs, optical disc drives (ODDs), magneto-optical discs, magneto-optical drives, floppy diskettes, floppy disk drives (ODDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or computing devices. In addition, those of ordinary skill in the art will recognize that devices such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. A method of implementing a neural network, comprising:
receiving data for a trained neural network including feature maps and weights;
reordering the feature maps and/or the weights of the trained neural network to generate a reordered version of the trained neural network; and
after performing the reordering, compressing weights of the reordered version of the trained neural network.

2. The method of claim 1, wherein the reordering comprises reordering the feature maps of the neural network to reorder the weights of the neural network.

3. The method of claim 1, wherein the reordering comprises reordering the weights of the neural network to have a structure selected to improve compression efficiency compared with the weights of the received data.

4. The method of claim 1, wherein the reordering comprises reordering at least some of the weights to distribute weights based on a load balancing consideration.

5. The method of claim 1, wherein the reordering comprises grouping at least some weights by weight value.

6. The method of claim of claim 5, wherein at least some zero-value weights are grouped.

7. The method of claim 1, further comprising clustering the weights, prior to reordering, by mapping weights within a first number of different weight values to a second number of different weight values, where the second number is less than the first number.

8. The method of claim 1, further comprising reordering, prior to compression, indices of weights of reordered input and output nodes.

9. The method of claim 1, wherein the reordered version of the trained neural network is an equivalent version of the trained neural network.

10. The method of claim 1, wherein the reordering comprises generating remapping tables for a neural network to implement a remapping of feature maps to implement the reordered version of the trained neural network.

11. A method of executing a neural network, comprising:
providing a model of a neural network, wherein the model corresponds to a reordered version of a trained neural network generated by reordering feature maps and/or weights of the trained neural network; and
executing the model of the neural network.

12. The method of claim 11, wherein executing the model comprises skipping execution of groups of weights having all zeros.

13. The method of claim 11, wherein executing the model comprises skipping execution of distributed zero-value weights in a convolution mode.

14. The method of claim 11, wherein the reordered version comprises an ordering of the weights based on a load balancing condition for execution on a set of parallel processing input units.

15. The method of claim 11, wherein the model of the neural network is executed on a set of parallel processing input units and the reordered version has non-zero weight values distributed based on a load balancing condition such that for at least one convolutional layer each parallel processing unit operates on about the same average number of non-zero weights per cycle over a plurality of cycles.

16. The method of claim of claim 11, wherein the model comprises remapping tables for a neural network to implement a remapping of feature maps to implement the reordered version of the trained neural network.

17. The method of claim 16, wherein the remapping tables are utilized by hardware during execution to perform a reordering of feature maps.

18. The method of claim 11, wherein the reordered version is an equivalent network to the trained neural network or an optimized version of the trained neural network

19. The method of claim 11, wherein weights of the neural network are stored in a compressed format and the method further comprises:
reading compressed weights;
decompressing the compressed weights;
skipping execution of zero-value weights, including at least one of skipping any clusters of weights in which all of the weights are zero for a fully connected layer or skipping execution of scattered zero-value weights for a convolution layer; and
applying the remaining decompressed weights for neural network execution.

20. A computer readable medium comprising a non-transitory storage medium storing instruction which when executed on a processor implement a method, comprising:
receiving data for a trained neural network including feature maps and weights;
reordering the feature maps and/or the weights of the trained neural network to generate a reordered version of the trained neural network; and
after performing the reordering, compressing weights of the reordered version of the trained neural network.
